(19) United States
(12) Patent Application Publication
(10) Pub. No.: US 2011/0059652 A1
(43) Pub. Date: Mar. 10, 2011

(54) MULTI-PATHWAY CONNECTOR FOR CIRCUIT BOARDS

(75) Inventors: Michael A. HOYACK, Sandy Hook, CT (US); Joachim GREK, Katrineholm (SE); Niklas PHILIPSSON, Knivsta (SE); Owen R. BARTHELMES, Putnam Valley, NY (US)

(73) Assignee: Amphenol Corporation, Wallingford, CT (US)

(21) Appl. No.: 12/557,107

(22) Filed: Sep. 10, 2009

(51) Int. Cl. H01R 13/40; H01R 24/00; H01R 13/648

(52) U.S. Cl. 439/607.31; 439/733.1; 439/626; 439/629

(57) ABSTRACT

A connector includes a contact and a housing that receives the contact. The contact includes at least first and second prongs and a tension portion joining the first and second prongs that biases the prongs away from one another. The housing includes a slot shaped to receive the contact such that the first and second prongs are forced together against the bias of the tension portion.

### FIELD OF THE INVENTION

The present invention relates to electrical connectors. In particular, the present invention relates to electrical connectors configured to couple circuit boards and adapted to transmit power, low frequency signals, or radiofrequency signals between the circuit boards.

### BACKGROUND OF THE INVENTION

When one printed circuit board must be electrically connected to another printed circuit board, several pathways must be provided between the two printed circuit boards. The several pathways include pathways for power signals, reference potentials, direct current signals, low frequency signals, or higher frequency radiofrequency signals. Each type of signal requires a connector with a specific construction to provide the optimal pathway for that type of signal with low signal loss. Such connectors include soldered wires, cable assemblies, or radiofrequency coaxial connectors.

However, there is a need in the art for a connector that can combine one or more of the pathways for different kinds of signals in a single housing. The connector should also be scalable to accommodate the various signals that must be transmitted between circuit boards. Furthermore, there is a need for a connector that can be mated when the circuit boards are not precisely aligned with each other.

### SUMMARY OF THE INVENTION

Accordingly, one aspect of the invention may provide a connector that includes a contact and a housing that receives the contact. The contact includes at least first and second prongs and a tension portion joining the first and second prongs that biases the prongs away from one another. The housing includes a slot shaped to receive the contact such that the first and second prongs are forced together against the bias of the tension portion.

Another aspect of the present invention may provide a connector that includes a contact, a housing having a slot that receives the contact, and a flange that extends from the housing. The contact includes a mating portion shaped substantially as a blade, and a coupling portion opposite the mating portion. The housing has a printed circuit board engaging surface, and the flange extends beyond the printed circuit board engaging surface of the housing. The flange substantially surrounds the mating portion of the contact.

Yet another aspect of the present invention may provide a connector assembly. The connector assembly includes a first connector and a second connector adapted to mate with the first connector. The first connector has a contact and a housing that receives the contact. The contact of the first connector includes a mating portion shaped substantially as a blade and a coupling portion opposite the mating portion. The second connector has a mating contact configured to mate with the contact of the first connector and a housing that receives the mating contact. The mating contact includes at least first and second prongs and a tension portion joining the first and second prongs that biases the prongs away from one another. The housing that receives the mating contact includes a slot shaped to receive the mating contact such that the first and second prongs are forced together against the bias of the tension portion.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of a connector assembly in accordance with an embodiment of the invention;

FIG. 2 is a top plan view of the connector assembly shown in FIG. 1;

FIG. 3 is a top plan view of a first connector of the connector assembly shown in FIG. 1;

FIG. 4 is a front elevational view of the first connector shown in FIG. 3;

FIG. 5 is a side elevational view of the first connector shown in FIG. 3 with a partial sectional view;

FIG. 6 is a bottom plan view of the first connector shown in FIG. 3;

FIG. 7 is a rear top perspective view of the first connector shown in FIG. 3;

FIG. 8 is a front bottom perspective view of the first connector shown in FIG. 3;

FIG. 9 is a top plan view of a second connector of the connector assembly shown in FIG. 1;

FIG. 10 is a front elevational view of the second connector shown in FIG. 9;

FIG. 11 is a side elevational view of the second connector shown in FIG. 9 with a partial sectional view;

FIG. 12 is a bottom plan view of the second connector shown in FIG. 9;

FIG. 13 is a rear top perspective view of the second connector shown in FIG. 9;

FIG. 14 is a front bottom perspective view of the second connector shown in FIG. 9;

FIG. 15 is a sectional, rear bottom perspective view of the second connector shown in FIG. 9 showing contacts received in the connector;

FIG. 16 is a side elevational view of the connector assembly shown in FIG. 1 showing the first and second connectors coupled in a first orientation;

FIG. 17 is a side elevational view of the connector assembly in accordance with another embodiment of the invention showing the first and second connectors coupled in a second orientation; and

FIG. 18 is a side elevational view of the connector assembly in accordance with yet another embodiment of the invention showing the first and second connectors coupled in a third orientation.

### DETAILED DESCRIPTION OF THE INVENTION

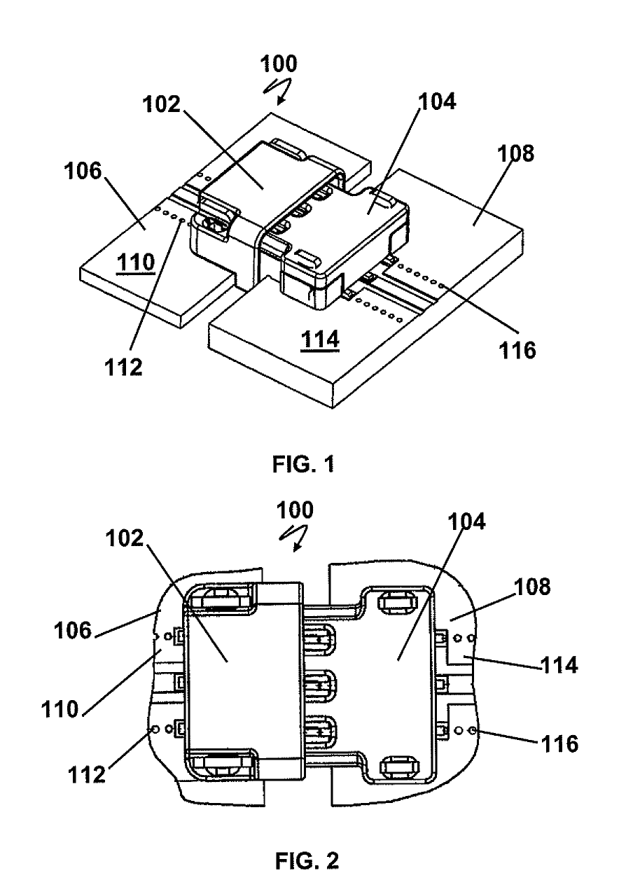

Referring to FIGS. 1-18, the present invention provides a connector assembly 100 that can provide one or more pathways for several different kinds of signals. The connector assembly 100 has a first connector 102 and a second connector 104. The connectors 102 and 104 are designed to float, that is they easily mate with one another even though the connectors 102 and 104 may not be perfectly aligned with one another. The first connector 102 and the second connector 104 may be scaled to provide one pathway for a signal or several pathways for one or more different kinds of signals, such as radiofrequency (RF), power, or ground. The connectors 102 and 104 are designed to allow for effective electrical and mechanical connection of printed circuit boards, such as mother and daughter circuit boards.

Referring to FIGS. 1 and 2, the connector assembly 100 is shown with the first connector 102 mated to the second connector 104. The first connector 102 is coupled to a first circuit board 106, and the second connector 104 is coupled to a second circuit board 108. The first circuit board 106 has a first surface 110. One or more first conductors 112, such as, but not limited to, conductive traces, surface mounts, vias, conductive through-holes, combinations of the aforementioned, or some other conductor, are placed on the first surface 110 of the first circuit board 106. Similarly, the second circuit board 108 also has a second surface 114 with one or more second conductors 116, such as, but not limited to, conductive traces, surface mounts, vias, conductive through-holes, combinations of the aforementioned, or some other conductor.

When the first connector 102 is mated to the second connector 104, the connector assembly 100 provides one or more pathways for signals, preferably RF signals, between the first circuit board 106 and the second circuit board 108. In particular, when the first connector 102 is mated to the second connector 104, the first connector 102 and the second connector 104 provide an electrical pathway between one or more of the first conductors 112 on the first surface 110 of the first circuit board 106 and one or more of the second conductors 116 on the second surface 114 of the second circuit board 108.

In the exemplary embodiment shown, the first surface 110 of the first circuit board 106 and the second surface 114 of the second circuit board 108 are shown substantially parallel to each other. However, in other embodiments, the first surface 110 and the second surface 114 need not be parallel to each other. Also, as best seen in FIG. 1, the first surface 110 and the second surface 114 are generally not coplanar with each other. Because of the design of the connector assembly 100, in such an embodiment in which the first surface 110 and the second surface 114 are not co-planar, the first connector 102 can still mate with the second connector 104 to provide an effective pathway between the first circuit board 106 and the second circuit board 108, as shown in FIG. 1.

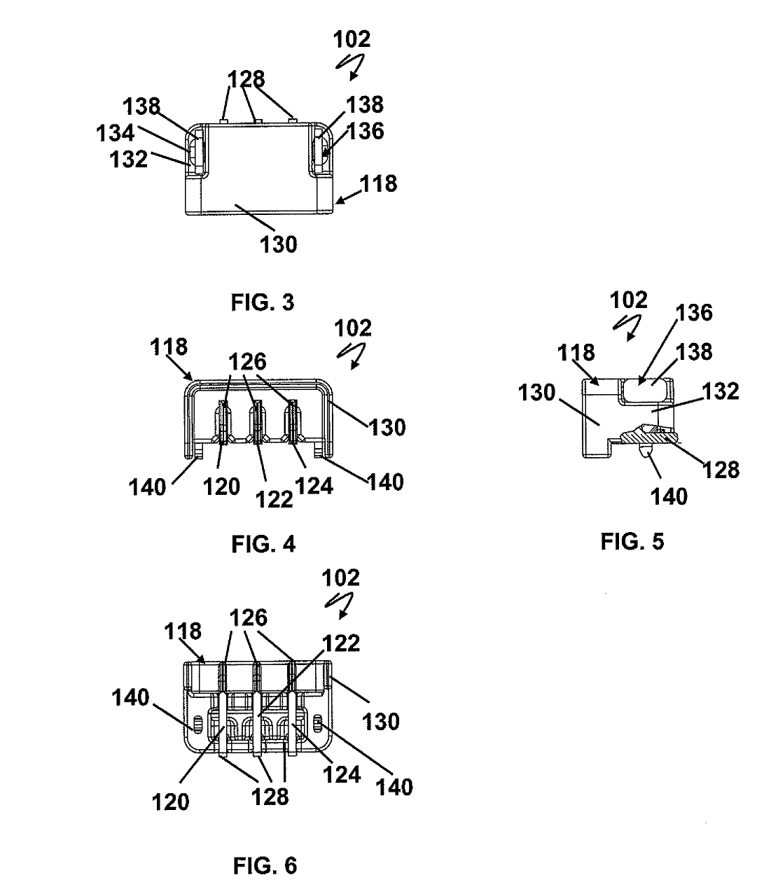

Referring to FIGS. 3-8, the first connector 102 may include at least one contact 120, 122, or 124; and a housing 118 that receives the at least one contact 120, 122, or 124. The at least one contact 120, 122, or 124 provides an electrical pathway between the one or more first conductors 112 of the first circuit board 106 and the second connector 104 of the connector assembly 100. Each contact 120, 122, and 124 is made from a conductive metal, alloy, compound, or some other material that conducts. Each contact 120, 122, and 124 may also have a plating or coating.

Preferably, each contact 120, 122, and 124 is first formed with a geometry that provides adequate mechanical integrity for each contact 120, 122, and 124. Then, while maintaining the mechanical integrity of each contact 120, 122, and 124, the shape of the contacts 120, 122, and 124 are further optimized for the type of electrical signal for which each contact 120, 122, and 124 provides a pathway.

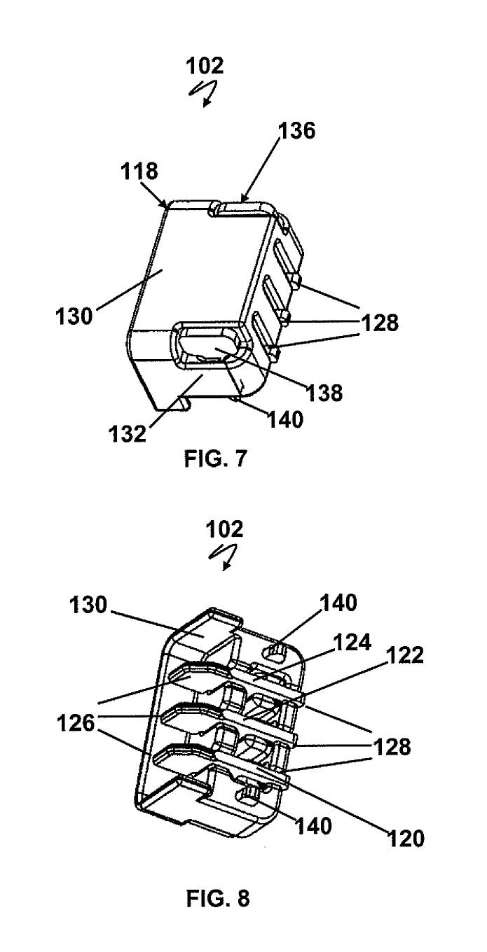

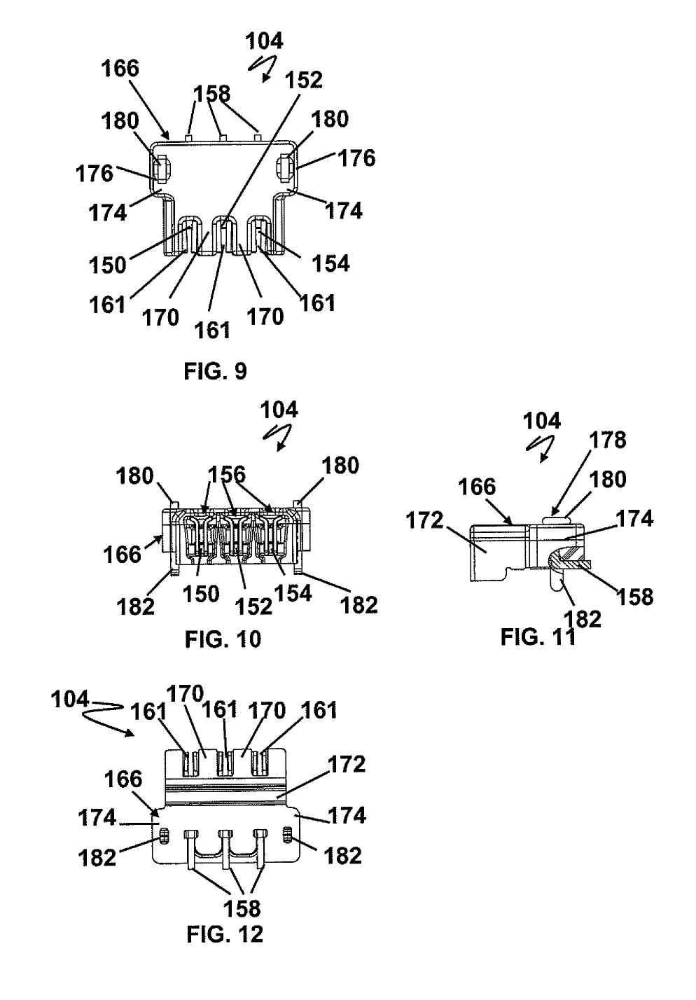

As best seen in FIGS. 7-8, each contact 120, 122, and 124 includes a mating portion 126 for mating with the second connector 104 and a coupling portion 128 for coupling with a first conductor 112 of the first circuit board 106. The mating portion 126 is shaped to be received by one of the mating contacts 150, 152, or 154 of the second connector 104 (shown in FIGS. 9-15). Each mating portion 126 of the contacts 120, 122, and 124 can be shaped substantially the same or differently to mate with the mating contacts 150, 152, or 154 of the second connector 104. The coupling portion 128 is shaped to form a mechanical and conductive coupling with a first conductor 112 on the first surface 110 of the first circuit board 106. The coupling portion 128 can be a joint for soldering, a press-fit contact, a joint for a conductive adhesive, combinations of the aforementioned, or some other coupling that provides a mechanical and conductive coupling. Each coupling portion 128 of the contacts 120, 122, and 124 can be a different type of coupling.

In a preferred embodiment, the first connector 102 has at least three contacts 120, 122, and 124. The outer contacts 120 and 124 preferably provide a pathway for a ground signal or a reference potential signal. The middle contact 122 provides a pathway for an electrical signal, such as an RF signal. Thus, the first connector 102 has contacts 120, 122, and 124 that are arranged to form a “ground-signal-ground” configuration. Such a “ground-signal-ground” configuration is useful for when the middle contact 122 provides a pathway for an RF signal. However, the number of contacts 120, 122, and 124 is not meant to be limiting. In other embodiments, the first connector 102 can have more than or less than the three contacts 120, 122, and 124 shown. The number of contacts 120, 122, and 124 is determined by the number of pathways that may be needed between the first circuit board 106 and the second circuit board 108. Also, in the embodiment shown, each contact 120, 122, and 124 includes a mating portion 126 that is shaped substantially as a blade and a coupling portion 128 that is adapted for soldering with one of the first conductors 112 of the first circuit board 106. The contacts 120, 122, and 124 are placed adjacent to each other such that the blade-shaped mating portions 126 are substantially parallel to each other. Furthermore, each contact 120, 122, and 124 is preferably made from beryllium copper with a gold plating. In an alternate embodiment, the plating may be made from silver.

The contacts 120, 122, and 124 are received in the housing 118. The contacts 120, 122, and 124 can be coupled to the housing 118 such that the mating forces that arise as the first connector 102 and the second connector 104 are mated are not substantially transmitted to the coupling portions 128 of each of the contacts 120, 122, and 124. Thus, in an embodiment where, for example, the coupling portion 128 is soldered to the first circuit board 106, the mating forces that arise between the first and second connectors 102 and 104 as they are mated are not substantially transmitted to the soldered joints between the contacts 120, 122, and 124 and the first circuit board 106. In one embodiment, the housing 118 has one or more slots 128 that each receives one of the contacts 120, 122, or 124. The slots 128 align the contacts 120, 122, and 124 relative to each other. The housing 118 can be made from an insulative material, such as, but not limited to insulative plastic such as liquid crystal polymers, thermoset, thermoset polyethylene, thermoplastic such as acrylic or acrylonitrile butadiene styrene, thermoplastic polymer such as polycarbonate, thermoplastic fluoropolymer, fluorocarbon-based polymer, polyethylene, polyvinyl chlorides, polyvinylidene fluoride, ethylene tetrafluoroethylene, polyaryletheretherketone (PEEK), silicone, glass, combinations of the aforementioned, or any other generally rigid material that is substantially insulative. In the embodiment shown, the housing 118 is preferably made from liquid crystal polymers (LCP). In an alternate embodiment, the housing 118 may be made from PEEK.

The housing 118 may also include a flange 130 that extends from the housing 118 and substantially around the mating portions 126 of the contacts 120, 122, and 124. The flange 130 can guide the second connector 104 to ensure proper alignment between the first connector 102 and the second connector 104 as they are being mated. In one embodiment, the flange 130 can be formed to receive the extending portion 172 of the second connector 104 (best seen in FIGS. 9, 12, and 13-15), thereby ensuring proper alignment between the first connector 102 and the second connector 104. The flange 130 may provide protection to the contacts 120, 122, and 124 of the first connector 120 when the first connector 120 and the second connector 104 are unmated. In the embodiment shown, the flange 130 surrounds the mating portions 126 except around the bottom near where the first connector 102 couples with the first circuit board 106. Also, as best seen in FIGS. 3-8, the flange 130 extends past the surface of the housing 118 that engages the first circuit board 106, and thus, the flange 130 extends past the first surface 110 of the first circuit board 106.

The housing 118 may also include one or more tabs 132. Each tab 132 may have one or more apertures 134. Each aperture 134 receives a pin 136. The tabs 132 extend from the housing 118 such that the first connector 102 can be coupled to the first surface 110 of the first circuit board 106 by the pin 136 extending through the aperture 134 in each tab 132. Alternatively, the housing 118 of the first connector 102 may be coupled to the first circuit board 106 by soldering; press-fit couplings; interference-fit couplings; interlocking mechanical parts, such as nuts and bolt or rivets; adhesives; combinations of the aforementioned; or some other coupling the mechanically couples the housing 118 to the first circuit board 106.

In the embodiment shown, the pin 136 includes a pin head 138 and a post 140 extending from the pin head 138. The post 140 is sized to be received in and extend through the aperture 134; however, the pin head 138 is preferably sized so that it cannot fit through the aperture 134. Thus, when each aperture 134 receives the pin 136, the post 140 extends through the aperture 134 to the first surface 110 of the first circuit board 106; however the post 140 does not extend any further because the pin head 138 cannot pass through the aperture 134. The post 140 extends past the aperture so that it can be coupled to the first surface 110. In the embodiment shown, an interference-fit preferably couples the post 140 to the first surface 110. Also, in the embodiment shown, the housing 118 has two tabs 132 on opposite sides of the housing 118, and each tab 132 has one aperture 134. With such a construction, when the apertures 134 receive the pins 136, the pins 136 can also align the housing 118, and thus the first connector 102, properly with respect to the first circuit board 106. Furthermore, the depicted pin 136 is preferably made from brass with a tin plating with a thickness of approximately 2.5 micrometer.

Referring to FIGS. 9-14, the second connector 104 of the connector assembly 100 is shown. The second connector 104 includes at least one mating contact 150, 152, or 154 that mates with a corresponding contact 120, 122, or 124 of the first connector 102; and a housing 155. The at least one mating contact 150, 152, or 154 provides an electrical pathway between at least one of the contacts 120, 122, or 124 and a second conductor 116 of the second circuit board 108. Each mating contact 150, 152, and 154 is preferably made from a conductive metal, alloy, compound, or some other material that conducts. Each mating contact 150, 152, and 154 may also have a plating or coating.

Preferably, each mating contact 150, 152, and 154 is first formed with a geometry that provides adequate mechanical integrity for each mating contact 150, 152, and 154. Then, while maintaining the mechanical integrity of each mating contact 150, 152, and 154, the shape of the mating contacts 150, 152, and 154 are further optimized for the type of electrical signal for which each mating contact 150, 152, and 154 provides a pathway.

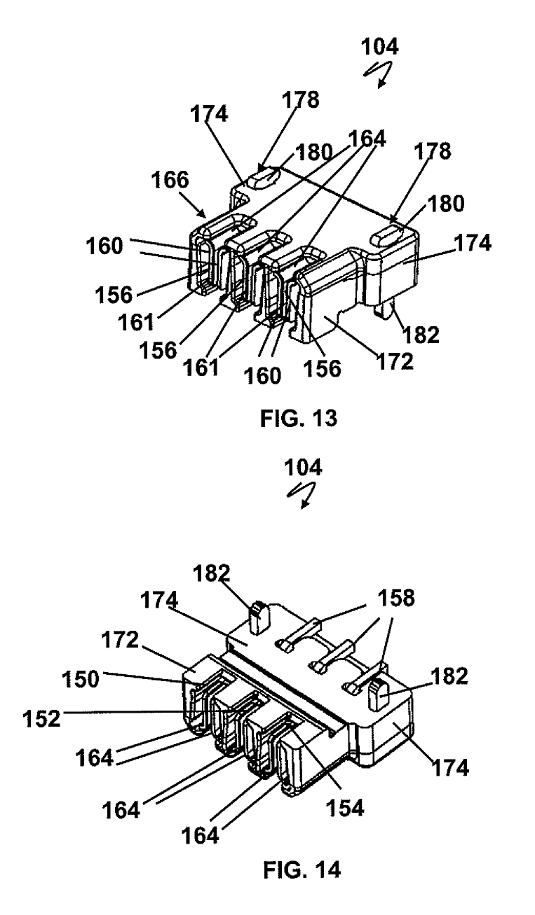

As best seen in FIGS. 13-15, each mating contact 150, 152, and 154 includes a mating portion 156 (FIG. 13) for mating with the contact 120, 122, or 124; and a coupling portion 158 for coupling to the circuit board 108. The mating portion 156 is shaped to receive one of the contacts 120, 122, or 124 of the first connector 102 (shown in FIGS. 3-8). Each mating portion 156 of the mating contacts 150, 152, and 154 can be shaped substantially the same or differently to mate with the contacts 120, 122, or 124 of the first connector 102. The coupling portion 158 is shaped to form a mechanical and conductive coupling with a second conductor 116 on the second surface 114 of the second circuit board 108. The coupling portion 158 can be a joint for soldering, a press-fit contact, a joint for a conductive adhesive, combinations of the aforementioned, or some other coupling that provides a mechanical and conductive coupling. Each coupling portion 158 of the contacts 150, 152, and 154 can be a different type of coupling.

In the embodiment shown, the second connector 104 has at least three mating contacts 150, 152, and 154. The outer mating contacts 150 and 154 preferably provide a pathway for a ground signal or a reference potential signal. The middle mating contact 152 preferably provides a pathway for an electrical signal. Thus, the second connector 104 has mating contacts 150, 152, and 154 that are arranged to form a “ground-signal-ground” configuration. Such a “ground-signal-ground” configuration is useful for when the middle mating contact 152 provides a pathway for an RF signal. However, the number of mating contacts 150, 152, and 154 is not meant to be limiting. In other embodiments, the second connector 104 can have more than or less than the three mating contacts 150, 152, and 154 shown. The number of mating contacts 150, 152, and 154 is determined by the number of pathways that may be needed between the first circuit board 106 and the second circuit board 108.

In an embodiment where, at least, one of the mating contacts 150, 152, and 154 provides a pathway for an RF signal, the spacing between and geometries of the mating contacts 150, 152, and 154 determine impedance to the RF signal in the connector assembly 100. The pathway for an RF signal should have an impedance substantially similar to the expected nominal impedance of the application in which the connector assembly 100 is to be used to minimize signal loss. If the impedance of the pathway is not substantially similar to the expected nominal impedance, then the RF signal experiences some signal reflection and thus signal loss. For example, in an application where the nominal impedance is expected to be approximately 50 Ohms, the contact assembly 100 should also have an impedance of approximately 50 Ohms between the contacts 120, 122, and 124 and the mating contacts 150, 152, and 154. Otherwise, the signal experiences signal reflection and thus signal loss. Low impedance or a capacitive impedance can be compensated for by a high impedance or an inductive impedance.

Also, in the embodiment shown, each mating contacts 150, 152, and 154 may include a mating portion 156 that may include two opposed prongs 160 with an area 161 between the prongs 160 adapted to receive a corresponding mating portion 126 of the first connector 102. The prongs 160 are joined at a tension portion 162 for each mating contact 150, 152, and 154. The tension portion 162 biases the opposed prongs 160 in a spaced apart manner. Furthermore, as best shown in FIGS. 10, 13, and 14, each prong 160 includes a wing 164 that extends upward from the prong 160 and away from the area 161. Thus, when a corresponding contact 120, 122, or 124 with a blade-shaped mating portion 126 approaches the mating contact 150, 152, or 154, one or more wings 164 on the mating contact 150, 152, or 154 guides the contact 120, 122, or 124 towards the area 161 between the prongs 160. Also, because two wings 164 can be placed on opposed prongs 160 with an air gap in between, the wings 164 can form a capacitor and thus a capacitive impedance to compensate for a high or inductive impedance. Thus, the wings 164 can be tuned to adjust the capacitance that compensates for the inductance formed from the board gap.

In the embodiment shown, each mating contact 150, 152, and 154 includes the coupling portion 158 that is adapted for soldering with one of the second conductors 116 of the second circuit board 108. Furthermore, in the embodiment shown, each mating contact 150, 152, and 154 is preferably made from beryllium copper with a gold plating. In an alternate embodiment, the plating may be made from silver.

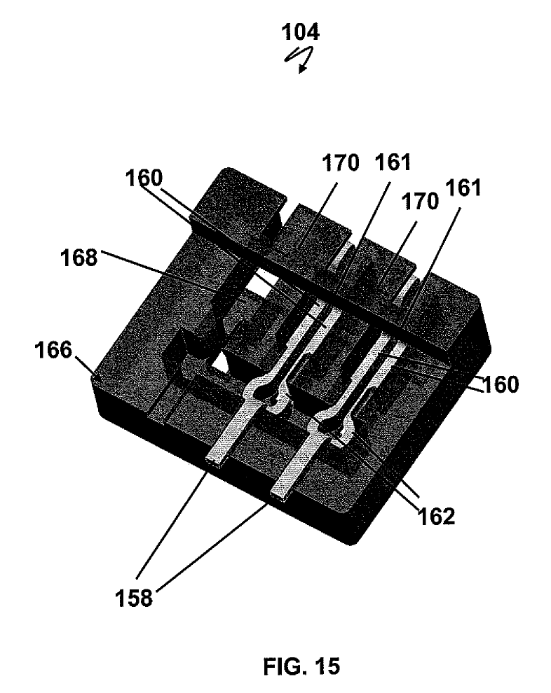

The mating contact 150, 152, and 154 are received in the housing 166, as best seen in FIG. 15. The mating contacts 150, 152, and 154 can be coupled to the housing 166 such that the mating forces that arise as the first connector 102 and the second connector 104 are mated are not substantially transmitted to the coupling portions 158 of each of the mating contacts 150, 152, and 154. Thus, in an embodiment where, for example, the coupling portion 158 is soldered to the second circuit board 108, the mating forces that arise between the first and second connectors 102 and 104 as they are mated are not substantially transmitted to the soldered joints between the mating contacts 150, 152, and 154 and the second circuit board 108. In one embodiment, the housing 166 has one or more slots 168 that each receives one of the mating contacts 150, 152, and 154. The slots 168 align the mating contacts 150, 152, and 154 relative to each other and press the prongs 160 of each mating contact 150, 152, and 154 together against the force of the tension portion 162. Also, between the slots 168 are shields 170. Because the shields 170 are between the slots 168 and thus the mating contacts 150, 152, and 154, the shields 170 can provide impedance balancing when one or more of the mating contacts 150, 152, and 154 provide a pathway for an RF signal. The housing 166 can be made from an insulative material, such as, but not limited to insulative plastic such as liquid crystal polymers, thermoset, thermoset polyethylene, thermoplastic such as acrylic or acrylonitrile butadiene styrene, thermoplastic polymer such as polycarbonate, thermoplastic fluoropolymer, fluorocarbon-based polymer, polyethylene, polyvinyl chlorides, polyvinylidene fluoride, ethylene tetrafluoroethylene, polyaryletheretherketone (PEEK), silicone, glass, combinations of the aforementioned, or any other generally rigid material that is substantially insulative. In the embodiment shown, the housing 166 is preferably made from liquid crystal polymers (LCP). In an alternate embodiment, the housing 118 may be made from PEEK.

The housing 166 may also include an extending portion 172 that is shaped to fit substantially within the partial flange 130 (best shown in FIGS. 4, 6, and 8) that extends from the housing 118 of the first connector 102. The extending portion 172 contains the mating contacts 150, 152, and 154; the slots 168 that receive the mating contacts 150, 152, and 154; and the shields 170 between the slots 168. Thus, when the partial flange 130 contacts the extending portion 172, the first connector 102 is properly aligned with the second connector 104, and the contacts 120, 122, and 124 of the first connector 102 are properly aligned and mated with the mating contacts 150, 152, and 154 of the second connector 104. Also, the partial flange 130 and the extending portion 172 provide substantially one direction for mating the first connector 102 with the second connector 104. Furthermore, as best seen in FIG. 14, the extending portion 172 extends past the second surface 114 of the second circuit board 108.

The housing 166 may also include one or more tabs 174. Each tab 174 has one or more apertures 176. Each aperture 176 receives a pin 178. The tabs 174 extend from the housing 166 such that the second connector 104 can be coupled to the second surface 114 of the second circuit board 108 by the pin 178 extending through the aperture 176 in each tab 174. Alternatively, the housing 166 of the second connector 104 can be coupled to the second circuit board 108 by soldering, press-fit couplings, interference-fit couplings; interlocking mechanical parts such as nuts and bolt or rivets, adhesives, combinations of the aforementioned, or some other coupling the mechanically couples the housing 166 to the second circuit board 108.

In the embodiment shown, the pin 178 preferably includes a pin head 180 and a post 182 extending from the pin head 180. The post 182 is sized to be received in and extend through the aperture 176; however, the pin head 180 is sized so that it cannot fit through the aperture 176. Thus, when each aperture 176 receives the pin 180, the post 182 extends through the aperture 176 to the second surface 114 of the second circuit board 108, but the post 182 cannot extend any further because the pin head 180 cannot pass through the aperture 176. The post 182 extends past the aperture so that it can be coupled to the second surface 114. In the embodiment shown, an interference-fit preferably couples the post 182 to the second surface 114. Also, in the embodiment shown, the housing 166 has two tabs 174 on opposite sides of the housing 166, and each tab 174 has one aperture 176. With such a construction, when the apertures 176 receive the pins 178, the pins 178 can also align the housing 166, and thus the second connector 104, properly with respect to the second circuit board 108. Furthermore, the depicted pin 178 is preferably made from brass with a tin plating with a thickness of approximately 2.5 micrometer.

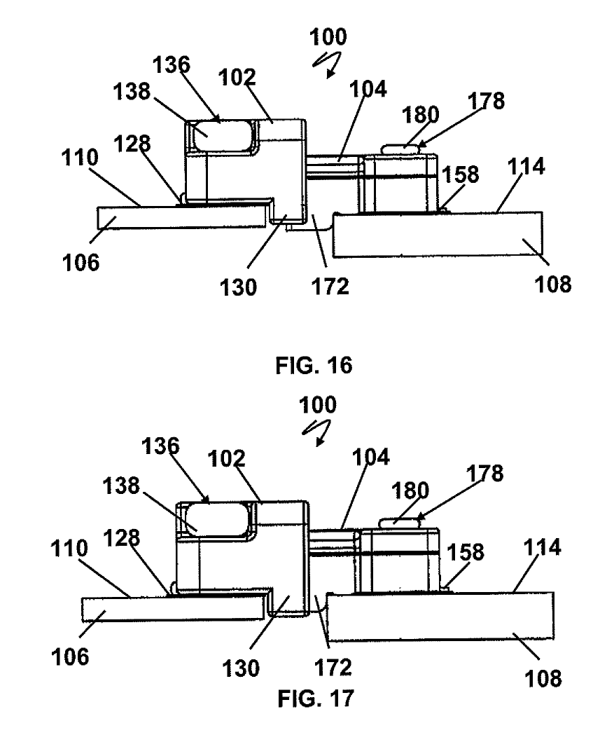

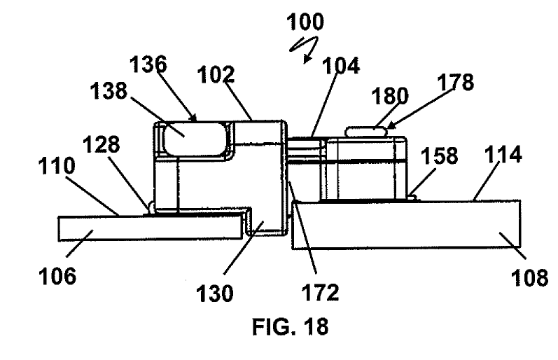

Referring to FIGS. 16-18, with construction described above, the connector assembly 100 can be coupled to the first circuit board 106 and the second circuit board 108; however the first circuit board 106 and the second circuit board 108 need not be perfectly co-planar with each other. Turning to FIG. 16, the connector assembly 100 is shown coupling the first circuit board 106 and the second circuit board 108 in a substantially parallel orientation but not perfectly co-planar with respect to each other. As shown in the figure, the first surface 110 of the first circuit board 106 is relatively higher than the second surface 114 of the second circuit board 108. Referring to FIG. 17, the connector assembly 100 is shown coupling the first circuit board 106 and the second circuit board 108 in a substantially parallel and substantially co-planar orientation with respect to each other. As shown in the figure, the first surface 110 of the first circuit board 106 is aligned with the second surface 114 of the second circuit board 108. Referring to FIG. 18, the connector assembly 100 is shown coupling the first circuit board 106 and the second circuit board 108 in a substantially parallel but not co-planar orientation with respect to each other. Unlike the first circuit board 106 and the second circuit board 108 of FIG. 16, the first surface 110 of the first circuit board 106 is relatively lower than the second surface 114 of the second circuit board 108.

As shown in FIGS. 16-18, when the first and second connectors 102 and 104 are mated, the contacts 120, 122, and 124 of the first connector 102 and the mating contacts 150, 152, and 154 of the second connector 104 are not exposed. Because the contacts 120, 122, and 124 of the first connector 102 are substantially surrounded by the flange 130 and the mating contacts 150, 152, and 154 of the second connector 104 are disposed in the extending portion 172, when the connectors 102 and 104 are mated, the flange 130 substantially surrounds and covers the extending portion 172. Thus, when the connectors 102 and 104 are mated, the contacts 120, 122, and 124 and the mating contacts 150, 152, and 154 are not exposed. In each orientation of the circuit boards 106 and 108 as shown in FIGS. 16-18, the contacts 120, 122, and 124 and the mating contacts 150, 152, and 154 are covered by the flange 130 and the extending portion 172. Furthermore, there is only a small gap between the first and second connectors 102 and 104 when coupled, as shown in FIG. 16-18.

As apparent from the foregoing description, the connector assembly 100 can provide one or more pathways for several different kinds of signals. The connector assembly 100 has a first connector 102 and a second connector 104. The first connector 102 can be mated to the second connector 104 even when the second connector 104 is not completely aligned with the first connector 102. The first connector 102 and the second connector 104 can be scaled to provide one pathway for a single signal or several pathways for one or more different kinds of signals, such as power, low frequency signals, or radiofrequency signals.

While particular embodiments have been chosen to illustrate the invention, it will be understood by those skilled in the art that various changes and modifications can be made therein without departing from the scope of the invention as defined in the appended claims.

What is claimed is:

1. A connector comprising:
a contact, said contact including,
at least first and second prongs, and
a tension portion joining said at least first and second prongs that biases said prongs away from one another; and
a housing that receives said contact, said housing including a slot being shaped to receive said contact such that said first and second prongs are forced together against the bias of said tension portion.

2. A connector according to claim 1, wherein said housing further comprises a shield adjacent to said contact.

3. A connector according to claim 2, wherein each of said first and second prongs has a wing, and said wings form a capacitor.

4. A connector according to claim 1, wherein said housing further comprises an extending portion that extends from said housing, the extending portion including said slot.

5. A connector according to claim 1, wherein the housing further comprises a tab extending from the housing, the tab having an aperture for a pin.

6. A connector according to claim 1, wherein said contact comprises a plurality of contacts.

7. A connector according to claim 6, wherein one contact of said plurality of contacts is adapted to convey a radiofrequency signal, two contacts of said plurality of contacts are adapted to convey a ground signal, and said two contacts of said plurality of contacts are placed adjacent to said one contact of said plurality of contacts.

8. A connector comprising:
a contact, the contact including,
a mating portion shaped substantially as a blade, and
a coupling portion opposite said mating portion;
a housing having a slot that receives said contact, said housing having a printed circuit board engaging surface; and
a flange extending from said housing that substantially surrounds said mating portion of said contact and extends beyond said printed circuit board engaging surface of said housing.

9. A connector according to claim 8, wherein said contact comprises a plurality of contacts.

10. A connector according to claim 9, wherein one contact of said plurality of contacts is adapted to convey a radiofrequency signal, two contacts of said plurality of contacts are adapted to convey a ground signal, and said two contacts of said plurality of contacts are placed adjacent to said one contact of said plurality of contacts.

11. A connector assembly, the connector assembly comprising:
a first connector including:
a contact, said contact having,
a mating portion shaped substantially as a blade, and
a coupling portion opposite said mating portion; and
a housing that receives said contact; and
a second connector adapted to mate with said first connector, said second connector including:
a mating contact configured to mate with said contact of said first connector, said mating contact having,
at least first and second prongs, and
a tension portion joining said at least first and second prongs that biases said prongs away from one another, and
a housing that receives said mating contact, said housing including a slot being shaped to receive the contact such that said first and second prongs are forced together against the bias of said tension portion.

12. A connector according to claim 11, wherein said housing of said second connector further comprises a shield adjacent to said mating contact.

13. A connector according to claim 11, wherein each of said first and second prongs further comprises a wing that guides said mating portion of said contact towards an area in between said first and second prongs.

14. A connector according to claim 11, wherein said housing of said second connector further comprises a tab extending from said housing, the tab having an aperture for a pin.

15. A connector according to claim 11, wherein said contact comprises a plurality of contacts.

16. A connector according to claim 15, wherein one contact of said plurality of contacts is adapted to convey a radiofrequency signal, two contacts of said plurality of contacts are adapted to convey a ground signal, and said two contacts of said plurality of contacts are placed adjacent to said one contact of said plurality of contacts.

17. A connector according to claim 11, wherein said first connector is coupled to a first circuit board, said second connector is coupled to a second circuit board, and said first and second circuit boards are substantially parallel to each other.

18. A connector according to claim 11, wherein said first connector is coupled to a first circuit board, said second connector is coupled to a second circuit board, and said first and second circuit boards are generally not co-planar with respect to each other.

19. A connector according to claim 11, wherein said contact of said first connector and said mating contact of said second connector are substantially surrounded when said first and second connectors are mated.

20. A connector according to claim 11, wherein
said first connector further comprises a flange that substantially surrounds said mating portion of said contact,
said housing of said second connector further comprises an extending portion that extends from said housing and includes said slot, and
said flange substantially surrounds said extending portion when said first and second connectors are mated.
